(19) United States
(12) Patent Application Publication
(10) Pub. No.: US 2005/0039168 A1
(43) Pub. Date: Feb. 17, 2005

(54) Web site management system with change management functionality

(76) Inventor: John R. Applin, Ft. Collins, CO (US)

Correspondence Address: HEWLETT PACKARD COMPANY, P O BOX 272400, 3404 E. HARMONY ROAD, INTELLECTUAL PROPERTY ADMINISTRATION, FORT COLLINS, CO, 80527-2400, US

(21) Appl. No.: 10/628,678

(22) Filed: Jul. 28, 2003

(51) Int. Cl. G06F 9/44

(52) U.S. Cl. 717/120; 717/108

(57) ABSTRACT

A web page management system comprising a change management subsystem and an assembly subsystem. The change management subsystem provides for a plurality of components and a parameter. An assembly subsystem provides for the creation of a web page from a subset of the plurality of components selectively identified using the parameter.

### BACKGROUND OF THE INVENTION

This invention relates generally to systems and methods (collectively “system”) for managing web sites. More particularly, the invention relates to web site management systems that include change management functionality.

Web sites provide an increasingly important medium for communications with customers, and for the distribution of software functionality. A single web site may have many different target audiences. Different consumers of web site content may require different versions of the same content. Internal and external users may desire to interact with different versions of software and other forms of web site content.

Existing web site management systems fail to provide the ability to dynamically invoke different versions of web site functionality. It would be desirable for web site management systems to include the functionality of change management applications. However, the historical evolution of web site technology affirmatively teaches away from the inclusion of change management functionality as a component of a web site management system. For various reasons, the World Wide Web has relied predominantly on static files of formatted text such as SGML (standard generalized markup language), HTML (hypertext markup language), and other markup “languages” to provide web site content. In contrast, change management applications are typically limited to the execution of programs, and not the processing of files. Thus, change management functionality has not been included in web site management systems and existing change management tools are incompatible with traditional web site components.

### BRIEF DESCRIPTION OF THE DRAWINGS

Some of the embodiments of the present invention will be described in detail, with reference to the following figures:

FIG. 1 shows an environmental diagram illustrating an example of a web site management system.

FIG. 2 shows a block diagram illustrating an example of a conventional linking structure.

FIG. 3 shows a block diagram illustrating an example of a centralized address index being used to manage web page addresses.

FIG. 4 shows a structural diagram illustrating an example of an index being used to provide link management functionality.

FIG. 5 shows a hierarchical diagram illustrating an example of a virtual (index) layer between a logical layer and a physical (address) layer.

FIG. 6a shows a hierarchical diagram illustrating an example of change management application structure.

FIG. 6b shows a hierarchical diagram illustrating an example of web site content stored in a manner consistent with a change management application.

FIG. 7 shows a process flow diagram illustrating an example of a change management application being invoked by a web site management system.

FIG. 8 shows a structural diagram illustrating an example of a subsystem-level view of a web site management system that includes a link subsystem and an index subsystem in providing link management functionality.

FIG. 9 shows a structural diagram illustrating an example of a subsystem-level view of a web site management system that includes a link subsystem, an index subsystem, a content subsystem, and a change management subsystem; a system that provides both link management and change management functionality.

FIG. 10 shows a structural diagram illustrating an example of a subsystem-level view of a web site management system that includes a link subsystem, an index subsystem, and a content subsystem in providing link management functionality.

FIG. 11 shows a structural diagram illustrating an example of a subsystem-level view of a web site management system that includes a change management subsystem and an assembly subsystem in providing change management functionality.

FIG. 12 shows a structural diagram illustrating an example of a subsystem-level view of a web site management system that includes an index subsystem, a change management subsystem, and an assembly subsystem; a system that provides both link management and change management functionality.

FIG. 13 shows a structural diagram illustrating an example of a subsystem-level view of a web site management system that includes a change management subsystem and an assembly subsystem in providing change management functionality.

FIG. 14 shows a flow chart illustrating an example of a web site management process that includes link management functionality.

FIG. 15 shows a flow chart illustrating an example of a web site management process that includes link management functionality.

FIG. 16 shows a flow chart illustrating an example of a web site management process that includes change management functionality.

FIG. 17 shows a flow chart illustrating an example of a web site management process that includes change management functionality.

Throughout the drawing figures, like reference numerals will be understood to refer to like parts and components.

### DETAILED DESCRIPTION

I. Overview and Introduction of Elements

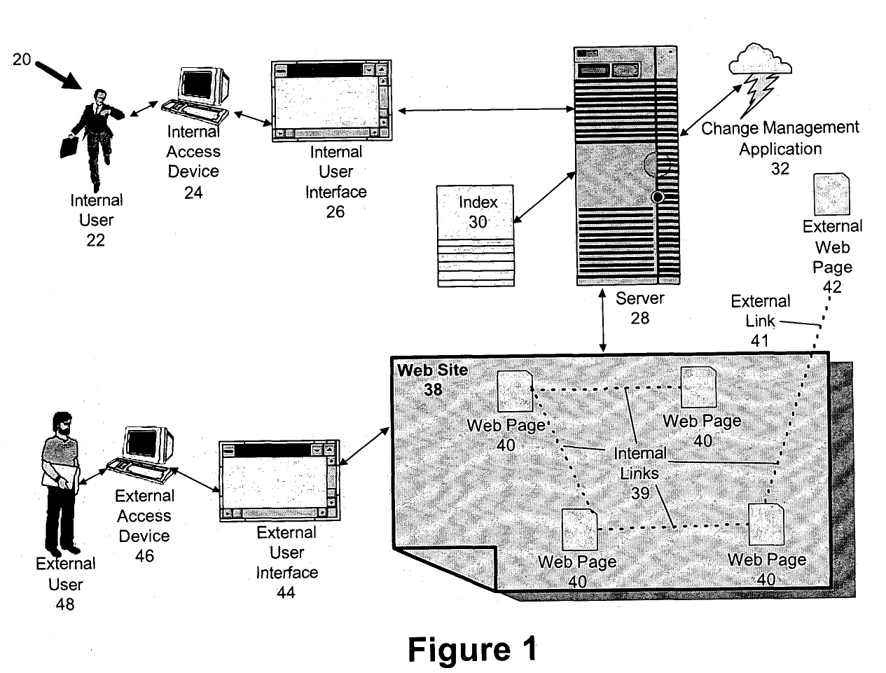

FIG. 1 is an environmental diagram illustrating one embodiment of a web site management system (collectively the “system”) 20. The embodiment of the system 20 in FIG. 1 includes both an index 30 for “link management functionality” and a change management application 32 for “change management functionality.” However, many different embodiments of the system 20 will not include both types of functionality.

A. Internal User

An internal user 22 is typically a person responsible for managing a web site 38. Some embodiments of the system 20 may have as few as a single internal user 22, but many embodiments will involve a far more numerous number of internal users 22 and there is no inherent limit to the number of internal users 22 that can utilize the functionality of the system 20. In many embodiments, the internal user 22 is an employee of the organization that sponsors or is otherwise associated with the web site 38. In other embodiments, the internal user 22 may be an outside contractor, an application service provider, or some other individual or organization with a relationship with the organization sponsoring the website (the “sponsoring organization”). Some embodiments of the system 20 may include intelligence technologies, such as neural networks, expert systems, artificial intelligence, and other forms of automated systems (collectively “intelligence technologies”). Such intelligence technologies can be used in conjunction with the system 20, and in those embodiments, the internal user 22 may be a device housing some form of intelligence technology.

The difference between the internal user 22 and an external user 48 is that external users 48 are consumers of the web site 38 while internal users 22 are providers or suppliers of the content on the web site 38. Thus, an external user 48 is not responsible for supporting or maintaining the functionality of the web site 38. The same individual can be an internal user 22 in one context and an external user 48 in another context.

B. Internal Access Device

An internal access device 24 is any device used by the internal user 22 to create, configure, manage, update, delete, or otherwise interact with the web site 38. The internal access device 24 can be a desktop computer, a laptop computer, a “dumb” terminal, a satellite pager, a cell phone, a personal digital assistant (PDA), a voice mail system utilizing voice recognition technology, a mini-computer, a work station, a network, or any other type of device (collectively “internal access device” 24) that can be used by the internal user 22 to interact with a server 28 hosting the web site 38. The system 20 can facilitate the use of many different types of internal access devices 24, and a wide variety of devices can be used in a simultaneous or substantially simultaneous manner.

The difference between the internal access device 24 and an external access device 46 mirrors in many respects the difference between internal users 22 and external users 48. A single device can be an internal access device 24 in one context and an external access device 46 in another context.

C. Internal User Interface

An internal user interface 26 is potentially any type of interface 26 used by the internal user 22 to access the server 28. The internal user interface 26 may be influenced by the hardware and operating system used by the server 28. For example, a server 28 running Linux will offer different commands and controls than a server 28 running Unix, NT, or some other operating system/network management software. The internal user interface 26 can also vary widely with respect to the particular implementation of the system 20. The system 20 can be configured to rely purely on text commands, or some type of graphical user interface (“GUI”) may be used. Voice recognition, menu structure, button controls, and other interface characteristics collectively make up the interface. The variety of different internal user interfaces 26 that can be incorporated into the system 20 is virtually limitless. Moreover, different internal user interfaces 26 can be utilized by an identical internal user 22 seeking to perform an identical function in an identical embodiment of the system 20. For example, to change an address for a particular web page, the internal users 22 may be able to “phone in” the change to some type of voice recognition technology interacting with the server 28. That same change could also potentially be implemented by using a web browser, logging in to an administrative page of the site, and making the appropriate change. Internal users 22 could also make the desired change in a more conventional manner, using a terminal or computer designated for interacting with the server 28.

The difference between the internal user interface 26 and an external user interface 44 mirrors in many respects the difference between internal users 22 and external users 48.

D. Server

A server 28 is potentially any type of device capable of hosting the web site 38. The capabilities of the server 28 should typically take into consideration the anticipated number of external users 48 and the types of activities to be invoked by those external users 48. The system 20 may be highly flexible and can incorporate future enhancements and developments in server 28 technology. A server 28 used to host a web site 38 can be a HTTP (“Hypertext Transfer Protocol”) server, an HTTPd (“Hypertext Transfer Protocol Daemon”) server, an HTTP-NG (“Hypertext Transfer Protocol Next Generation”) server, an HTTPS (“Hypertext Transfer Protocol Secure”) server, and FTP (“File Transfer Protocol”) server, or any other type of server now used or later developed to provide content to external users 48 through the World Wide Web or a similar network such as an intranet, extranet, or other network capable of supporting the interactive functionality of “pages” such as a web page 40. Servers 28 can also be referred to as web servers 28.

E. Index

An index 30 is potentially any mechanism used to locate the addresses used by various links to invoke web pages 40. The index 30 can take the form of a wide variety of different mechanisms. The index 30 can be a data base, a flat file, an array, a database table, a hash table, an object-oriented software object, or any other structure capable of storing address information. In some embodiments, the index 30 does not involve a structure for storing address information. For example, a dynamic look-up heuristic could be used to search the web pages 40 of web site 38 for the correct address information. In some embodiments, there will be only one centralized index 30 for the entire web site 38. In other embodiments involving highly compartmentalized groupings of web pages 40, it might be beneficial to include a separate index 30 for each grouping of web pages 40.

The index 30 is described in greater detail below.

F. Change Management Application

A change management application 32 is a software application used to store, process, and track different versions of various computer programs. For example, a particular word processing program might exist in various versions, such as version 1.0, version 2.0 etc. The system 20 can apply change management functionality to the components of the web site 38. Software can be differentiated on the basis of a date stamp, a date-time stamp, a version identifier, the identity of the external user 48 invoking the web site 38, or various other relevant characteristics (collectively “identifying characteristics”). The change management application 32 selects the appropriate components from a library of components to build the web pages for use by the user. The change management application 32 uses one or more parameter values to determine which components to use from the library of components, and which web pages 40 to build.

The change management application 32 is described in greater detail below.

G. Web Site

A web site 38 is a group of related web pages 40 hosted on the server 28. Web sites 38 include components such as associated files, scripts, and databases that are served up by the server 28 on the World Wide Web. Most web sites 38 have a home web page 40 as their starting point, which frequently functions as a table of contents for the site 38. The web pages 40 affiliated with a particular web site 38 typically share a common domain name. However, the server 28 can host more than one web site 38, and a single web site 38 can reside on multiple servers 28.

H. Web Page

A web site 38 is made up of one or more web pages 40. Web page 40 locations can be identified in the form of URL (“uniform resource locator”), or any other type of address usable to navigate the World Wide Web or similar network. Web pages 40 can exist in a wide variety of different formats, including SGML (“standard generalized markup language”), HTML (“hypertext markup language”), XSL (“extensible stylesheet language”), XML (“extensible markup language”), or any other type of format used on the World Wide Web. The external user 48 of the web site 28 can navigate from web page 40 to web page 40 using various forms of links.

A source web page is the web page 40 on which a particular link 39 is located. A target web page (which can also be called a destination web page 40) is the web page 40 pointed to by the particular link 39 that can be invoked by the activation of the particular link 39. Many web pages 40 are both source web pages 40 and target web pages 40 at the same time.

I. External Web Page

An external web page 42 is a web page belonging to a different web site 38 than the web page 40 containing the invoked link. External web pages 42 can also be referred to as foreign web pages 42 or remote web pages 42. The “external” status of a target web page is relative to the web site 38 affiliation of the source web page containing the invoked link.

J. Internal Link

Web pages 40 can be linked together by a variety of different methods and structures. One common form of a link is a hyperlink or hypertext link, a form of a link that provides a useful label to the user that masks the particular web page 40 address invoked by the activating the link. Links can incorporate a wide variety of different verbal and non-verbal characteristics, and in this embodiment, nothing in the system 20 limits the types of links that can be used.

An internal link 39 is a link between two web pages 40 that belong to a common web site 38. If the link points to an external web page 42, then the link can be referred to as an external link 41.

K. External Link

An external link 41 is any link located on the web site 38 that points to the external web page 42, e.g. a web page located on an foreign or external web site. In terms of structure, external links 42 can include the diverse range of structures of internal links 39.

L. External User Interface

An external user interface 44 is potentially any interface that allows an external user 48 to interact with the web site 38. External users 48 typically interact with the external user interfaces 44 through web browsers such as INTERNET EXPLORER® and NETSCAPE®. The external user interface 44 includes collectively all aspects of the web site 38 that the external user 48 can directly interact with. The interface can include the display of text, menu items that can be selected, data fields that can receive typed input, voice recognition technologies, light pens, mice, and any other input/output device.

M. External Access Device

An external access device 46 is any type of device that allows an external user 48 to access the web site 38. Any type of device that can be an internal access device 24 can also serve as an external access device 46. The mere ability to access web sites 38 typically requires less functionality and processing power than tasks relating to maintaining web sites 38, and thus external access devices 46 are more likely to be handheld, wireless, and/or non-traditional computation devices than internal access devices 24.

N. External User

An external user 48 is potentially any user visiting the web site 38 without responsibility for maintaining the web site 38. External users 48, in contrast to internal users 20, are consumers of the web site 38. Automated web agents, transaction tools, and other forms of intelligence technologies can be external users 48 of the system 20. A user can be an internal user 20 in one context while being an external user 48 in another context. The type of user depends on the type of activities being conducted.

II. Link Management Functionality

A. Conventional Link Structure

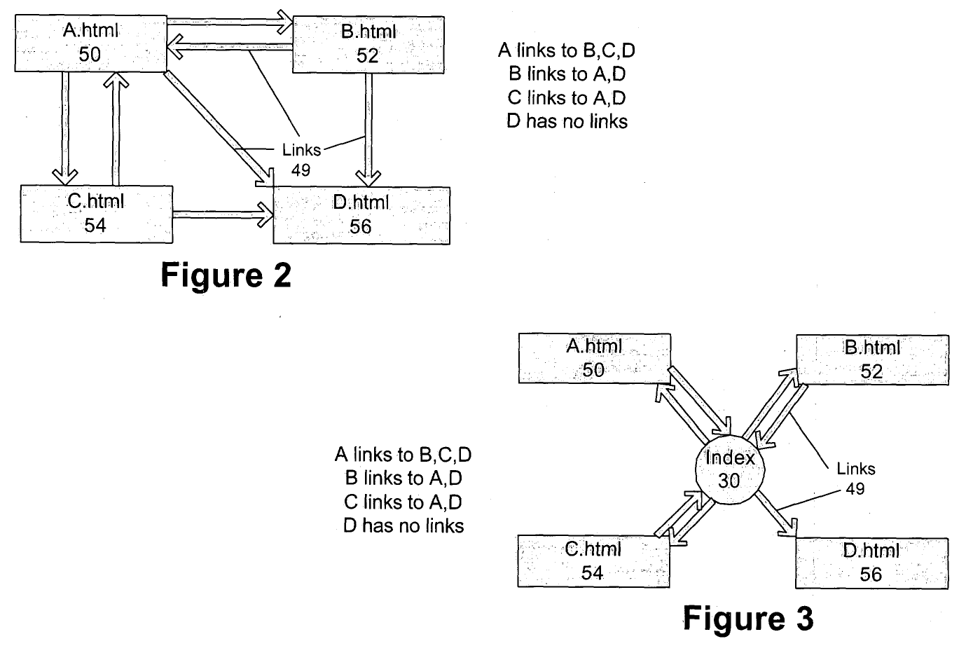

FIG. 2 shows a block diagram illustrating an example of a conventional linking structure that can be incorporated into a web site management system 20. In the illustration, the web pages 40 are written in HTML. As discussed above, the system 20 can incorporate pages utilizing a wide variety of different formats, and the links 49 between the various web pages 40 can also be in variety of different forms utilizing a wide variety of different techniques.

An A.html page 50 includes links 49 to a B.html page 52, a C.html page 54, and a D.html page 56. The B.html page 52 includes links 49 to the A.html page 50 and the D.html page 56. The C.html page 54 includes links 49 to the A.html page 50 and the D.html page 56. The D.html page 56 does not include any links 49 to any other web pages 40.

In the example of FIG. 2, there are three links 49 to the D.html page 56 (A.html 50, B.html 52, and C.html 54). Each of these links 49 includes the same address for the D.html page 56. A change in the address for the D.html page 56 thus requires that three addresses and three links 49 to be changed.

There are two links 49 to the A.html page 50 (B.html 52 and C.html 54), so any change in the address for the A.html change requires the changing of two links 49 and two addresses.

The web site 38 disclosed in FIG. 2 involves a relatively small number of web pages 40 and links 49. Many web sites 38 involve far more web pages 40, and a greater number of links 49 between those web pages. Many web sites 38 involve menu structures that can be manipulated from a web page 40 associated with the web site 38. In a fully cross-linked web site 38, there are N(N−1) links 49, with each link 49 possessing one web page 40 address in a “hard coded” manner.

Some embodiments of the system 20 can include the conventional link structure in conjunction with change management functionality. However, other embodiments of the system 20 can utilize link management functionality that uses an index 30 to store the various links 49 so that any address change for a particular web page 40 need only be made once, and in only one place. Such an advantage is increasingly significant the greater the number of links 49 in the web site 38.

B. Enhanced Link Management Functionality

FIG. 3 shows a block diagram illustrating an example of an index 30 of addresses being used to manage links 49, and the addresses referenced in those links 49. For the purposes of illustration and comparison, the link functionality in FIG. 3 is identical to the link functionality disclosed in FIG. 3. However, the structure and management of that functionality is significantly different.

Each address is stored in the index 30. Each address is stored only once, and in one location. Address information is not “hard coded” within the link itself. Instead all of the various links 49 point to the index 30 to obtain web page 40 address information. Thus, the three links 49 for invoking D.html 56 need only reference a single index location in the index 30 to invoke the D.html 56 page. A change in the address of the D.html 56 page need only be made once, in the appropriate address location in the index 30.

The advantages of enhanced link management functionality can be exponentially related to the number of interlinked web pages 40. In a web site 38 of “N” fully interconnected web pages 40, a conventional link management structure involves N(N−1). The number of links would be N² except for the fact that a web page 40 need not provide a link 49 to itself. Each link 49 includes an embedded or “hard coded” address for a web page 40 in the conventional structure.

In contrast, a system 20 using an index requires that each web page 40 address be referenced only once within the index 30. All links 49 can reference the address located in a single index location. As N (the number of interconnected web pages 40) increases, the advantages of the index 30 methodology also increase.

TABLE A

| | # of Addresses in a | # of Addresses in an Index |
|---|---|---|
| N= | Conventional Approach | Approach |
| 2 | 2 | 2 |
| 5 | 20 | 5 |
| 10 | 90 | 10 |
| 20 | 380 | 20 |
| 25 | 600 | 25 |
| 100 | 9,900 | 100 |
| 200 | 39,800 | 200 |
| 500 | 249,500 | 500 |
| 1,000 | 999,000 | 1,000 |
| 10,000 | 99,990,000 | 10,000 |
| N | N(N − 1) | N |

In FIG. 3, each link 49 includes a link 49 from the source web page to the index 30, and a link 49 from the index 30 to the target web page. However, other linking structures can be incorporated into the system 20. For example, a single link 49 could access the appropriate address from the index 30 and invoke the target web page located at that particular address. In still other embodiments, the index 30 of addresses can be used by the web pages 40 themselves so that movement of a web page 40 can occur by changing the address in the index 30. As discussed above, different embodiments may utilize a wide variety of different index 30 structures. In some embodiments, the index 30 is not a structure, but is instead a dynamic look-up heuristic that searches for the current address for the desired web page 40. In such an embodiment, each invocation of a link 49 on the web site 38 can result in the performance of the dynamic look-up heuristic.

C. One Example of an Index Structure

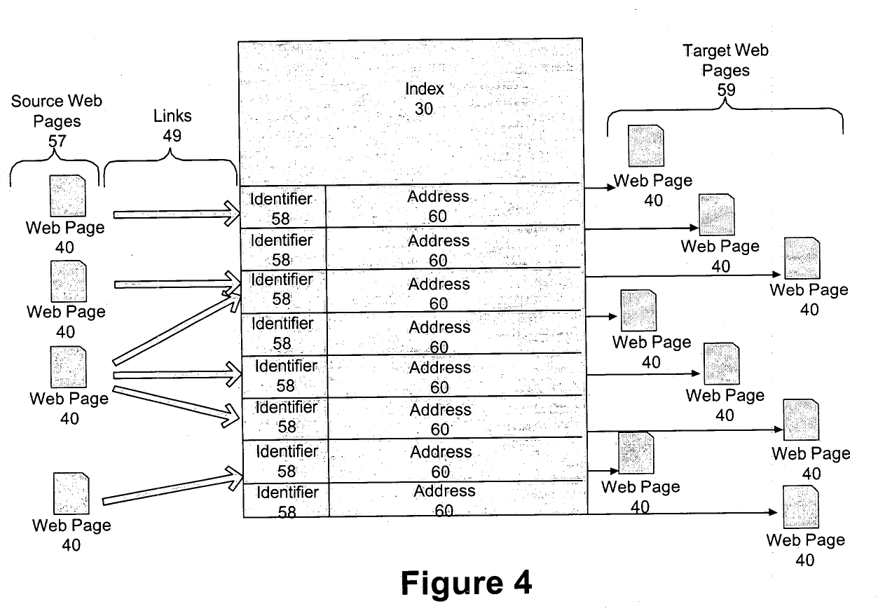

FIG. 4 shows a structural diagram illustrating an example of an index 30 being used to provide link management functionality. Web pages 40 mark both the initial location of the user with respect to the web site 38 and the final destination of the user. Links 49 are located on source web pages 57, and the invoking of a link 49 will ultimately bring up the target web page 59. A web page 40 can be both a source web page 57 and a target web page 59.

Various different structures and methods can be used to perform the functionality of invoking a target web page 59 from a source web page 57. In FIG. 4, the index 30 is some type of data structure, object-oriented software object, data base table, or other data type. An identifier field 58 is the reference value that indicates what web page 40 is to be brought up when the link 49 is invoked. Each identifier 58 has an address 60 that corresponds to the identifier 58. Examples of potential identifiers 58 include page 5, about us, order entry, and contact us. In some embodiments, the identifier 58 is not a separate field, and instead, is represented by the location of the particular address 60. For example. In an array, the identifier 58 could simply be the position of the particular address 60 in the array of addresses. In some embodiments, the index 30 is a dynamic look-up heuristic, and thus does not include any type of structure as the index 30 while performing the same functionality.

As indicated in FIG. 4, some source web pages 57 have only one link 49 while other source web pages 57 have more than one link. The example is not a fully interconnected web site 38. Some target web pages 59 are “pointed to” by any links 49. In some embodiments, identifiers 58 and addresses 60 for those web pages 40 can be removed from the index 30 since they are not used. In other embodiments, they are kept in the index 30 to support future changes in the link structure.

The links 49 accessing the index 30 can be static links. The link management functionality of the system 20 can be provided without involving any “active” components. In some embodiments, there is also a link 49 between the index 30 and the target web site 59. Such links 49 can also be static links without any “active” components. If change management functionality is included in the system 20, dynamic links 49 can be selected on the basis of one or more parameter values as described below.

There is no limit to the number of web pages 40 that can make up a web site 38 or that can be managed by the system 20. The links 49 on the source web pages 57 of a web site 38 can point to foreign web pages 42 and even web pages 40 located on different servers 28. There need not be any affiliation or communication between the various organizations sponsoring the various web sites 38.

D. A Layer-Based View of the Link Management Functionality

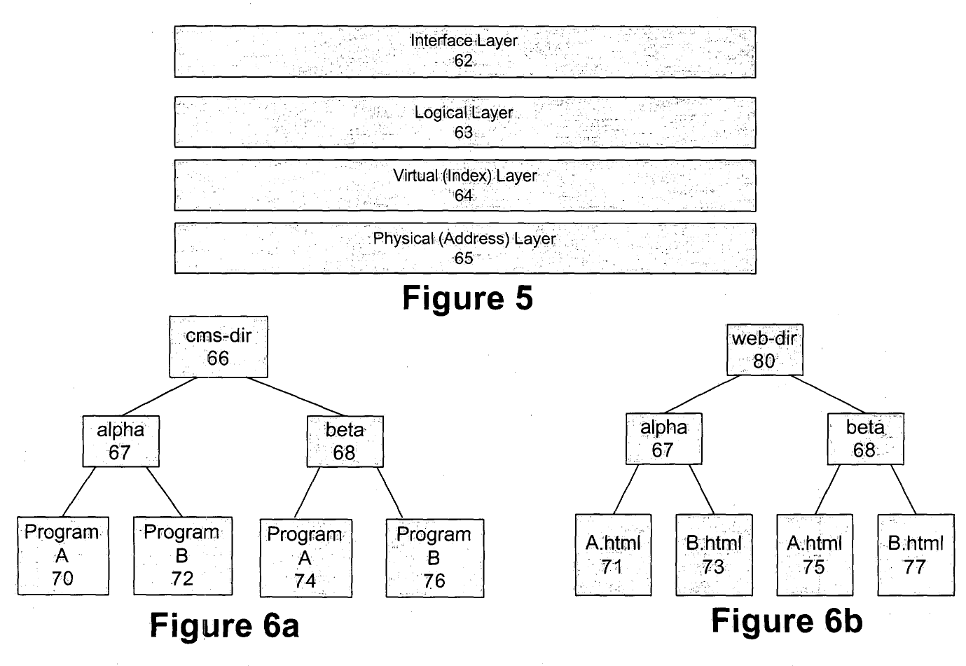

FIG. 5 shows a layer-based view of the system 20 illustrating an example of a virtual (index) layer 64 between a logical layer 63 and a physical (address) layer 65. The conventional links structure of FIG. 2 would not include the virtual (index) layer 64. The inclusion of a virtual layer 64 between the logical layer 63 and the physical layer 65 renders the logical layer 63 independent of the physical layer 65. In such an arrangement, the logical layer 63 need not be cognizant of the physical layer 65 because the virtual layer 64 serves as the interface between the logical layer 63 and the physical layer 65. The identifier 58 in FIG. 4 is the virtual representation for the physical address 60 in FIG. 4. The address 60 data in FIG. 4 makes up the physical layer 65. The user interfaces in FIG. 1 make up the interface layer 62. External users 48 of the system 20 will typically not be aware that the link management functionality is operating, and thus will not be able to distinguish between the structures of FIG. 2 and FIG. 3.

III. Change Management Functionality

A. Directory Structure

FIG. 6a shows a hierarchical diagram illustrating an example of change management application structure. FIG. 6a discloses the use of a data storage hierarchy to associate executable software. The system 20 is not limited to change management functionality that relies on a storage hierarchy.

A change management system directory (“cms-dir” or “system directory”) 66 is used to store different versions of various executable computer programs and related files. The system directory 66 is made up of various subdirectories relating to particular versions of the software subject to the change management functionality. In FIG. 6a, there is an alpha subdirectory 67 for storage of an alpha version of software and a beta directory 68 for storing a beta version of the software. There is no inherent limit to the number of subdirectories that can be used. In many embodiments, a hierarchy of subdirectories can be several subdirectories deep. Due to the limited size of the figures, only two subdirectories are illustrated in FIG. 6a.

Both the alpha and beta versions include versions of computer program A (70 and 74) and a computer program B (72 and 76). Computer program A is referenced by two different element numbers to indicate that the computer program A in the alpha directory 66 is different than the computer program A in the beta directory 68. Similarly, the computer program B 72 in the alpha directory 66 is different than the computer program B in the beta directory 68.

FIG. 6b shows a hierarchical diagram illustrating an example of web site content stored in a manner consistent with the change management functionality provided by the change management application 32. Changes made to the structure of FIG. 6b should be permeated to the structure of FIG. 6a, and vice versa.

A system-wide directory for all web site content (“web-dir”) 80 includes all components relating to all versions of the web site 38. An alpha subdirectory 67 is used for storage of the alpha version of web site 38 and the beta directory 68 for storing a beta version of the web site 38. Different versions of web page A (71 and 75) and web page B (73 and 77) are stored in the various subdirectories.

B. One Example of a Component-Based View

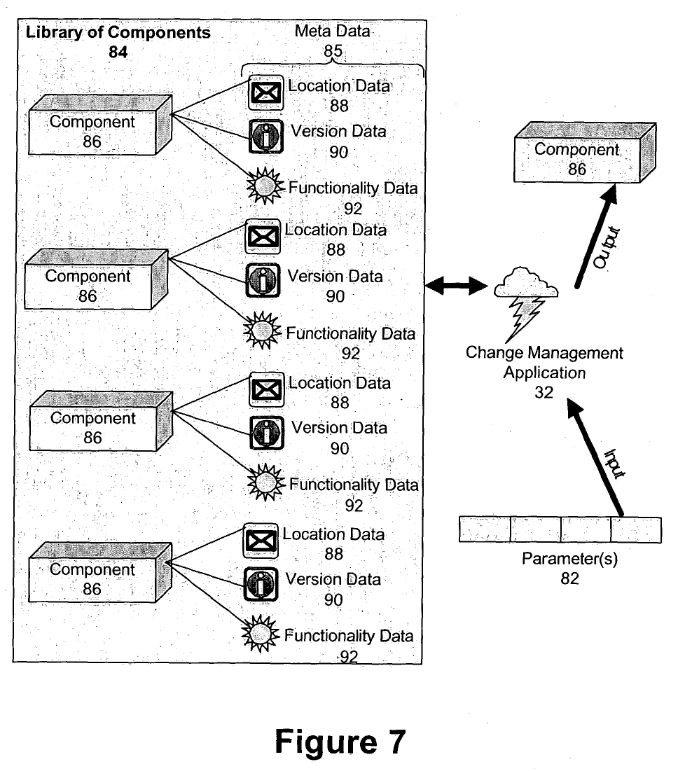

As mentioned above, change management functionality does not necessarily require a hierarchical file structure. FIG. 7 shows a process flow diagram illustrating an example of the change management application 32 being invoked by a web site management system 20. In FIG. 7, different types of meta data 85 are used in the change management process.

A library of components 84 includes various components 86 that can be used by the system 20 and the change management application 32 to dynamically create web pages 40. Web pages 40 are built from a subset of selectively identified components 86 located in the library of components 84.

Each component 86 can be associated with various metadata that can be used by the system 20 to support various automated processing. Location data 88 relates to the address information for the particular component 86. Version data 90 provides a way to store “version” information in a way that differs from the hierarchical directory approach of FIGS. 6a and 6b. Functionality data 92 describes the functionality or utility of the particular component 86. Meta data 86 can also include other characteristics such as a check out status, authorship, read authority, write authority, and other characteristics useful to library management (collectively “meta data” 86). In some embodiments, each component 86 includes the same types of meta data 86. For example, each component 86 may have a check-out status, although only those components 86 that are checked out will have a check-out status of “yes.” In alternative embodiments, meta data 86 need not be stored in predefined fields corresponding to specific types of meta data 86.

The input to the change management application 32 is one or more parameters 82. Parameter data can include: a version such as alpha or beta; a date stamp, such as Mar. 19, 2002; a date-time stamp, such as Mar. 19, 2002 at 4:00 p.m. EST; an audience-based characteristic such as a user-identification or organization identification; or any other basis for distinguishing between different components 86 for use in the web site 38. Parameter(s) 82 can relate to location data 88, version data 90, functionality data 92, or other types of meta data 86. Parameters 82 can be inputted from users through a user interface. Parameters 82 can also include profile information relating to the user or organization. For example, a particular user my choose to stick with version 1.0 of a complicated software application because that user is comfortable with version 1.0 and does not want to learn how to use version 2.0.

The output to the change management application 32 is one or more components 86 selected from the library of components 84 on the basis of one or more parameters 82. The various components 86 can then be dynamically assembled by the system 20 using some type of script or executable computer program in accordance with the data previously submitted as parameters 82. In many embodiments, the script is a cgi-bin script. Cgi-bin is an acronym for “common gateway interface” script. The “bin” indicates a binary file. A cgi-bin script is an external application that is executed by the server 28 in response to a request by a user interface 44. Generally, the cgi-bin script is invoked when the user clicks on some element in a web page 40, such as a link 49. Communication between the cgi-bin script and the server 28 is carried out via the cgi-bin specification. Cgi-bin “scripts” can be in the form of batch or compiled computer programs.

The change management application 32 can incorporate a wide variety of different types and combination of meta data 86. The modular approach of the change management functionality is consistent with the modular approach of using the index 30 of addresses to encapsulate the complexity of specific address 60 information for specific web pages 40.

Change management functionality provides a way to add substantial flexibility in the way that web-based services are provided to users. Change management functionality can provide for highly configurable user access control, historical information about the web site 38, the ability to access data remotely, and various other functions. In some embodiments of the system 20, links 49 are resolved by the system 20 at the time that the source web page (e.g. the web page 40 on which the link 49 is located) is fetched or invoked by the change management functionality. In other embodiments, links 49 are resolved at link-traversal time.

IV. Subsystem-Level Views

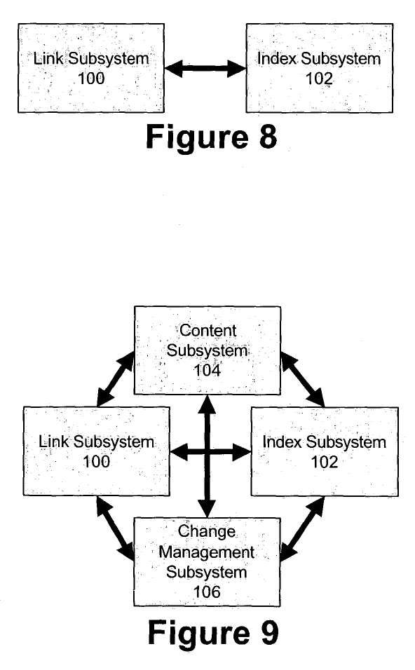

The system 20 can be described in various subsystem-level views. FIGS. 8, 9, 10, 11, 12, and 13 each disclose different embodiments of the system 20, with different subsystem-level configurations. In each subsystem-level configuration, each subsystem is connected to each other subsystem with a two-directional arrow, signifying that any subsystem can directly interact with any other subsystem.

A. Different Subsystem-Level Views and Configurations
1. Subsystem-Level View 1

FIG. 8 is a block diagram of an embodiment of the system 20 that includes link management functionality but not change management functionality. A link subsystem 100 includes the various links 49 used in the web site 40, including external links 41 pointing to foreign web pages 42. An index subsystem includes the various addresses 60 used by the links 49 to invoke target web pages 59. In some embodiments, the link 49 located on the source web page 57 accesses the address 60 from the index 30 and directly invokes the target web page 59. In other embodiments, a separate set of links 49 connect the index 30 to the target web pages 59. Each address 60 in the index 30 of addresses is an address 60 for a web page 40.

The index subsystem 102 can include a dynamic look-up heuristic in place of a formal data structure. Such a heuristic can perform the same functionality as an index 30 data structure by dynamically searching for a target web page 59 using techniques similar to that of a search engine.
2. Subsystem-Level View 2

FIG. 9 is a block diagram of an embodiment of the system 20 that includes both link management functionality and change management functionality. In addition to the link subsystem 100 and index subsystem 102 described above, a content subsystem 104 is used to store the various web pages 40 managed by the system 20. The content subsystem 104 includes the target web pages 59 and source web pages 57 linked together by the links 49 of the link subsystem 100 with the addresses 60 located in the index 30 of the index subsystem 102.

A change management subsystem 106 is used to track, identify, and process the various components 86 of the web site 38 consistent with the change management functionality described above. The change management subsystem 106 is responsible for the receiving the parameter(s) used to identify a subset of components 86 from the library of components 84.
3. Subsystem-Level View 3

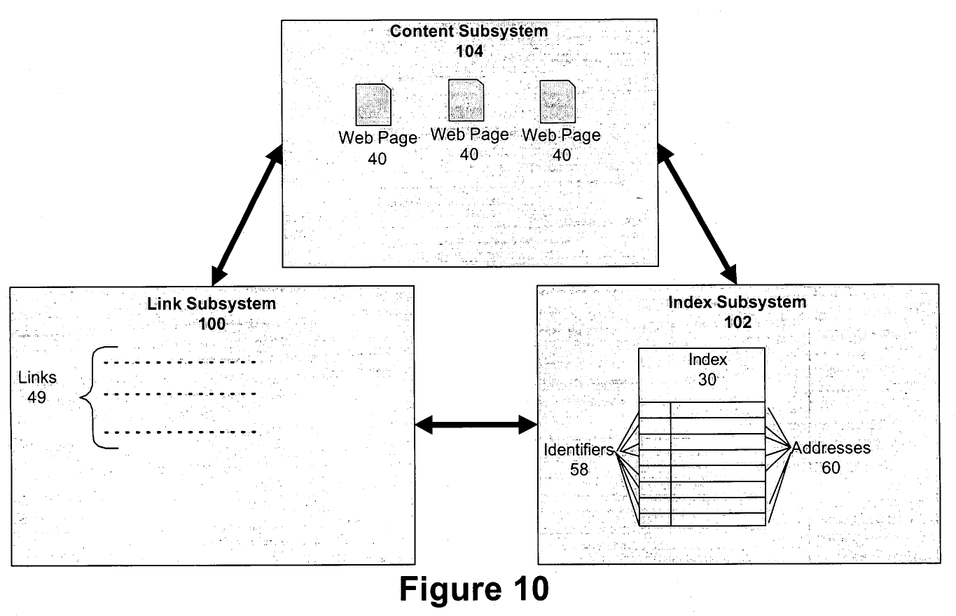

FIG. 10 is a block diagram illustrating an embodiment of the system 20 that includes only link management functionality. The content subsystem 104 includes all web pages 40, related files and components, and potentially any other embodiment of web page 40 content. Links 49 (both internal and external) are created, stored, and accessed in the link subsystem 100. Such links 49 can be static or dynamic. The links 49 in FIG. 10 are not “hard coded” with web page addresses 60. Instead, they point to identifiers 58 in the index 30, with each identifier 58 pointing to a particular web page 40 address 60 that need only be changed once and in one place to accommodate a change in the web page 40 address 60. In many embodiments of the system 20 as configured in FIG. 10, there are no “active” components.
4. Subsystem-Level View 4

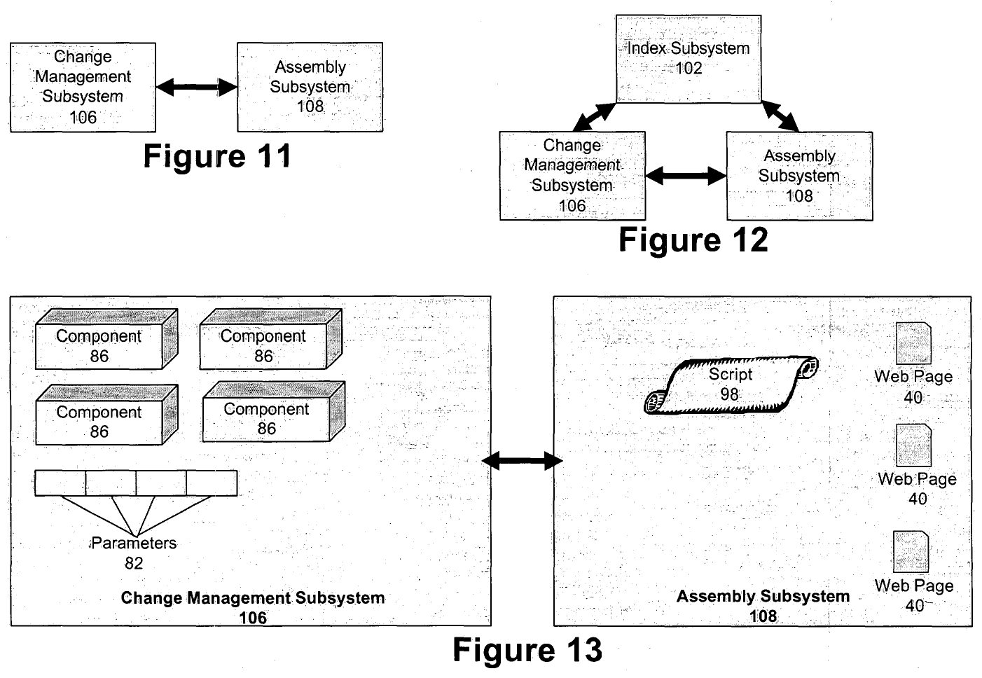

FIG. 11 is a block diagram illustrating an embodiment of the system 20 that includes only change management functionality. The change management subsystem 106 provides for various components 86 and at least one parameter 82 that can be used to selectively identify the one or more components 86 needed to create the appropriate web page 40. The assembly of the web page 40 from the selectively identified components 86 is performed by an assembly subsystem 108. The assembly subsystem 108 can invoke a script such as a cgi-bin script to assemble web pages 40 from the components 86. Multiple web pages 40 can be created in a simultaneous or substantially simultaneous manner. The various components 86 include different variations and versions of the same content, and thus multiple versions of the same web pages 40 can be created in a simultaneous or substantially simultaneous manner.

In some embodiments, only a single parameter 82 (such as a version identifier) is used to assemble web pages 40. In other embodiments, multiple parameters 82 and even multiple combinations of parameters 82 can be used to create highly nuanced and targeted web site 38 activities. Parameter values 82 can be received through user interfaces in a wide variety of ways. Some of those means involve express data input. Other means involve ongoing profiles that exist without the express knowledge of the user. Both internal user interfaces 26 and external user interfaces 44 can be used to set, modify, and delete parameter values 82.

In some embodiments, the web page 40 creation process is highly dynamic. The web page 40 is not created until after the web page 40 is invoked through a user interface 44 requiring the particular web page 40. Accordingly, the parameter(s) 82 may not be provided to the change management subsystem 106 until the moment in time in which the particular web page 40 is invoked. In other words, web pages 40 need not be assembled from their component parts until after user activities and profiles (parameter 82 data can also be associated on the basis of user profiles and preferences) determine the web page 40 that needs to be invoked.

In a preferred embodiment, each component 86 is an executable computer program. In alternative embodiments, anywhere from 0-100% of components 86 are executable computer programs.
5. Subsystem-Level View 5

FIG. 12 is a block diagram illustrating an embodiment of the system 20 that includes both change management functionality and link management functionality.

In addition to the change management subsystem 106 and assembly subsystem 108 of FIG. 11, this embodiment includes the index subsystem 102 described above. The system 20 disclosed in FIG. 12 includes the virtual layer 64 as a buffer between logical relationships and detailed address information. The index subsystem 102 provides a modularized approach to link management functionality that is consistent with the modularized approach of change management functionality.
6. Subsystem-Level View 6

FIG. 13 is a block diagram illustrating an embodiment of the system 20 that includes only change management functionality. FIG. 13 is a more detailed version of FIG. 11.

The change management subsystem 106 includes the various components 86 in the library of components 84, as well as the parameters 82 used to selectively identify the appropriate subset of components 84. The assembly subsystem 108 uses a script 98, such as a cgi-bin script, and the resources of the change management subsystem 106 to assemble the various web pages 40.

B. Subsystem Components
1. Link Subsystem

The link subsystem 100 is disclosed in FIGS. 8, 9, and 10. The link subsystem 100 includes all of the links 49 used for the link management functionality of the system 20. In some embodiments of the system 20, the link subsystem 100 also includes all of the various web pages 40 that can be invoked through the web site 38. In some embodiments, web pages 40 are located in different subsystems, such as a content subsystem 104 or an index subsystem 102.
2. Index Subsystem

The index subsystem 102 is disclosed in FIGS. 8, 9, 10, and 12. The index subsystem 102 includes the index 30 used to manage the links 49 located in the web pages 40 of the web site 38. In some embodiments of the system 20, the index subsystem 100 also includes all of the various web pages 40 that can be invoked through the web site 38. In some embodiments, the various web pages 40 are stored in different subsystems, such as a content subsystem 104. The index subsystem 102 should be included in system 20 embodiments that include link management functionality.

C. Content Subsystem

FIGS. 9 and 10 show structural diagrams illustrating examples of a subsystem-level view of a web site management system 20 that includes a content subsystem 104. The content subsystem 104 can include the various web pages 40 and components 86 that can used by the system 20. In some embodiments, it is the content subsystem 104 that includes the library of components 84 displayed in FIG. 7. In other embodiments, the change management subsystem 106 includes the library of components 84 in addition to the various parameter values 82.

D. Change Management Subsystem

FIG. 9 discloses an example of a change management subsystem 106 being used in conjunction with subsystems directed towards link management, such as the index subsystem 102. Examples of subsystem configurations including change management subsystem 106 are also disclosed in FIGS. 11, 12, and 13. The change management subsystem 106 includes the change management application 32. In some embodiments, such as the diagram in FIG. 13, the components 86 and parameter(s) 82 used to dynamically create web pages 40 are included as part of the change management subsystem 106.

E. Assembly Subsystem

FIGS. 11, 12, and 13 disclose subsystem-configurations that include the assembly subsystem 108. The assembly subsystem 108 interacts with the change management subsystem 106 to assemble web pages 40 using a script 98, such as a cgi-bin script.

V. Process Flow Views

A. Link Management
1. First Embodiment

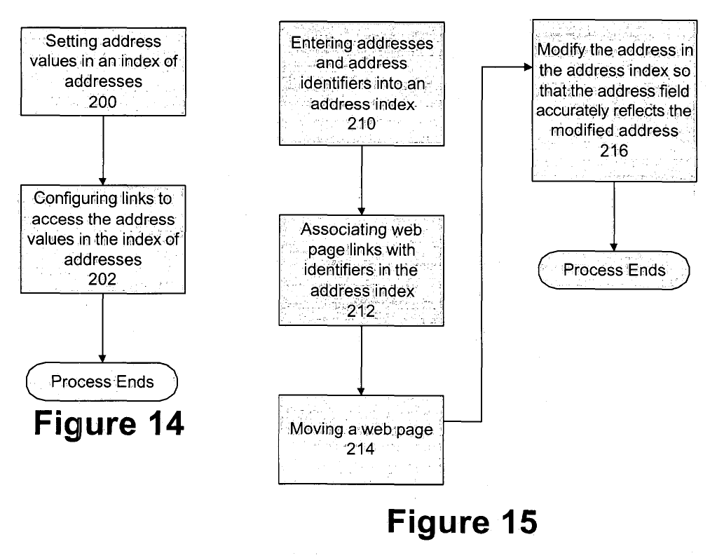

FIG. 14 shows a flow chart illustrating an example of a link management process. Address values 60 in the index 30 are set at 200. Links 49 are configured to access the address values 60 in the index 30 at 202.

Links 49 can be set to various target web pages 59 through various different means using the internal user interface 26. Movement of a web page 40 with an address 60 already listed in the index 30 simply requires changing the address 50 listed in the index. None of the links 49 should be “hard coded” with address values. Thus, modification of one or more web page addresses should not require any changes to the links 49. Similarly, adding a web page 40 requires that the web page address be entered only once in the index 30, where it can be accessed by many different links 49.

In many embodiments, there is only one centralized index 30 and each web page 40 is listed only once within the index 30. In alternative embodiments, different groupings of web pages can have their own indexes 30, and a single web page address 60 can be listed in more than one index 30.

If the underlying domain name for the web site 40 changes, all of the address values for internal web pages 40 would need to be changed in the index 30, but none of the links would need to be altered.

If a change management subsystem 108 is included in the functionality of the system 20, a change history provided by the change management application 32 can include changes made to the index 30.
2. Second Embodiment

FIG. 15 shows a flow chart illustrating a second example of a link management process. The index 30 is populated at 210 with addresses 60 and identifiers 58. Links 49 to the various web pages 40 can then be associated with the appropriate identifiers 58 in the index 30. Each address 60 should be associated with a unique identifier 58. At 212, links 49 are associated with identifiers 58 that were associated with addresses at 210.

A web page 40 change requiring a change in address 60 is performed at 214 through the use of the internal user interface 26. At 216, the address value 60 in the index 30 is modified to accurately reflect the updated address 60. In some embodiments, web pages 40 use the index 30 for their own address information. No links 49 need be changed.

In an embodiment of the system 20 involving only one index 30, the movement of a web page 30 requires the modification of only address 60 in the index 30. This is true even if numerous other web pages 40 include links 49 the moved target web page. Because the links 49 pointing towards the moved web page 40 point to the address value 60 in the index 30, movement of the target web page does not require any changes to be made to the links 49. Only the address value 60 in the index 30 needs to be changed.

As web pages 40 are added to the web site 38, addresses 60 for those added web pages 40 can also be added to the index 30. Similarly, when web pages 40 are deleted from the web site 38, the addresses 60 for the deleted web pages 40 should be removed from the index 30.

The system 20 disclosed in FIGS. 14 and 15 can interface with a change management application 32 or a change management subsystem 106. The change management functionality can be used to track changes in addresses 60 as well as changes in web page content. In such a system 20, each web page 40 can in the form of one or more executable computer programs.

B. Change Management
1. First Embodiment

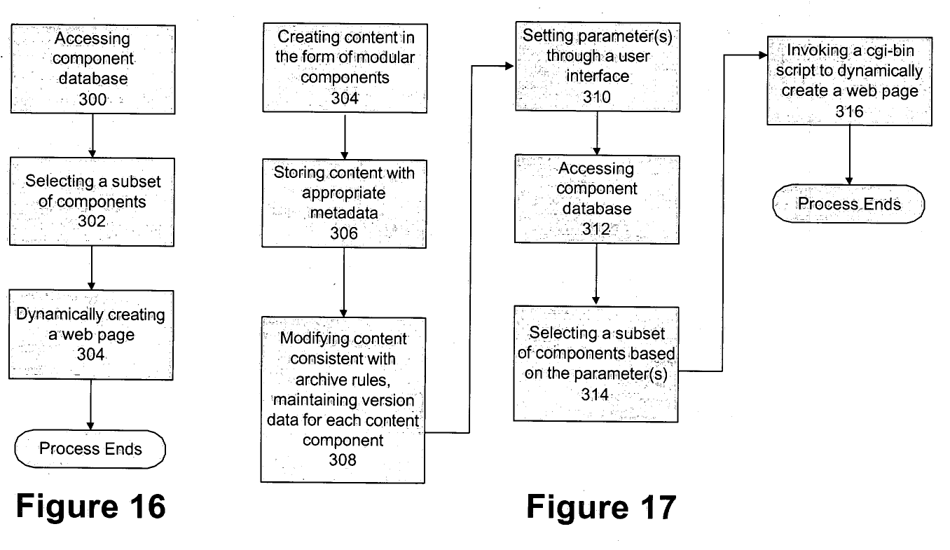

FIG. 16 shows a flow chart illustrating an example of a change management process. A component database is accessed at 200. The components in the component database include different versions of the same component. A subset of components are selected at 202 through the use of one or more parameter values 82. The selection is based on one or more parameters 82 received from the external user interface 44. In some embodiments, the external user 48 expressly sets the one or more parameter values 82. The web page 40 or web pages 40 can then be dynamically created at 304.

As various components 86 are “modified” the older version as well as the updated version are both stored as components 86 in the library of components 84. Depending on the parameter(s) 82 sent to the system 20, the updated component can be extracted in a dynamic manner upon receipt of an invocation of the web page 40 from the user interface.

Scripts 98, such as cgi-bin scripts, are invoked to assemble the selectively identified components 86 into the appropriate web pages 40. In a preferred embodiment, all of the components 86 are preferably executable programs. In alternative embodiments, some components 86 can be flat files.

In an embodiment that includes link management functionality, the links 49 located on the created web page 40 includes populating the web page with links 49 that point to an index 30 of web page addresses 60.
2. Second Embodiment

FIG. 17 shows a flow chart illustrating a second example of a change management process.

Content is created at 304. Such content takes the form of various modular components 86 which are preferably in the form of executable programs. At 306, meta data 85 as discussed in detail above, is associated with the appropriate content components 86. At 308, content is modified consistent with the rules of the change management application 32. Version data 90 is stored for each content component. Other advantages involved with change management functionality can also occur at 308. User access control, web site history, remote data access, and other benefits associated with change management functionality are available at 308.

To invoke various web pages 40 in the web site 38, parameter(s) 82 are set through the external user interface 44. Upon receipt of the parameter(s) 82, the database of components is accessed at 312. At 314, a subset of components are selectively identified using the value or values included as parameters 82.

The web page 40 is assembled by the invocation of the cgi-bin or other form of script 98, to dynamically create a web page 40.

VI. Alternative Embodiments

While the present invention has been particularly shown and described with reference to the foregoing preferred and alternative embodiments, those skilled in the art will understand that many variations may be made therein without departing from the spirit and scope of the invention as defined in the following claims. This description of the invention should be understood to include all novel and non-obvious combinations of elements described herein, and claims may be presented in this or a later application to any novel and non-obvious combination of these elements. The foregoing embodiments are illustrative, and no single feature or element is essential to all possible combinations that may be claimed in this or a later application. Where the claims recite “a” or “a first” element or the equivalent thereof, such claims should be understood to include incorporation of one or more such elements, neither requiring nor excluding two or more such elements.

1. A web page management system, comprising:
a change management subsystem, providing for a plurality of components and a parameter; and
an assembly subsystem providing for the creation of a web page from a subset of said plurality of components selectively identified using said parameter.

2. The system of claim 1, wherein said assembly subsystem provides for the dynamic creation of said web page from said components and from said parameter at the time said web page is invoked through a user interface.

3. The system of claim 1, wherein said plurality of components is a plurality of executable programs.

4. The system of claim 1, said change management subsystem further including a plurality of parameters.

5. The system of claim 4, wherein said assembly subsystem provides for the dynamic creation of said web page from at least two parameters from said plurality of parameters.

6. The system of claim 1, wherein said parameter is received from a user interface.

7. The system of claim 6, wherein said user interface is an external user interface.

8. The system of claim 6, wherein said user interface is an internal user interface.

9. The system of claim 1, wherein said parameter is a version identifier.

10. The system of claim 1, wherein said parameter is a date.

11. The system of claim 1, wherein said assembly subsystem invokes a script to create said web page.

12. The system of claim 11, wherein said script is a cgi-bin script.

13. The system of claim 1, wherein said assembly subsystem provides for the creation of a plurality of web pages.

14. The system of claim 1, wherein said plurality of components include a first component and a second component, wherein said first component is an older version of said second component.

15. The system of claim 1, further comprising a plurality of links and an index, wherein said index provides for storing a plurality of addresses accessible to said plurality of links.

16. The system of claim 15, further comprising a plurality of web pages, wherein said plurality of links invoke said plurality of web pages through at least one address stored in said index.

17. A web page management system comprising,
a plurality of web pages;
a web server;
a parameter;
a script; and
a plurality of components;
wherein said web server provides for the creation of said plurality of web pages from a subset of components selectively identified with said parameter; and wherein said script provides for the assembly of said plurality of web pages from said subset of selectively identified components.

18. The system of claim 17, wherein said script is a cgi-bin script.

19. The system of claim 17, said web server including a change management application, wherein said change management application provides for the dynamic creation of said plurality of web pages through the invocation of said script.

20. The system of claim 17, wherein each component in said plurality of components includes a checkout status.

21. The system of claim 17, further comprising a centralized index of addresses and a plurality of links, wherein said index of addresses determine the web pages pointed to by said plurality of links.

22. A web site management system, comprising:
interface means providing for the capture of input characteristics;
change management means providing for the storing of a plurality of components and a plurality of parameters; and
assembly means providing for the creation of a web page from a subset of said plurality of components and a subset of said plurality of parameters,
wherein said subset of parameters are selectively identified using said input characteristics; and
wherein said subset of components are selectively identified using said subset of parameters.

23. A method for managing web pages, comprising:
accessing a component database including a plurality of components, wherein said plurality of components includes a first component and a prior version of said first component;
selecting a subset of said plurality of components using a parameter; and
creating a web page from said subset of components.

24. The method of claim 23, further comprising invoking a cgi-bin script to dynamically create the web page.

25. The method of claim 23, further comprising setting said parameter through a user interface.

26. The method of claim 23, further comprising retrieving address data from an index for a link.

27. The method of claim 23, wherein at least 75% of the components in said plurality of components are executable programs.

28. The method of claim 23, further comprising modifying one said component, and extracting the modified component in a dynamic manner upon receipt of an invocation of said web page from a user interface.

29. The method of claim 23, wherein said web page includes links pointing to a foreign web page residing on a foreign web server.

30. The method of claim 23, further comprising retrieving said parameter from a user interface.

31. The method of claim 23, wherein at least one web page in said plurality of web pages is both a source web page and a target web page.

32. A web page, comprising:
a component database including a plurality of components, wherein said plurality of components includes a first component and a prior version of said first component; and
a web page, including a parameter, wherein said parameter is used to select a subset of said plurality of components for said web page.
